(19) United States
(12) Patent Application Publication
(10) Pub. No.: US 2006/0134588 A1
(43) Pub. Date: Jun. 22, 2006

(54) Method and apparatus for teaching

(76) Inventor: Meliesa Hawley, Wenatchee, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/302,456

(22) Filed: Dec. 12, 2005

Related U.S. Application Data
(60) Provisional application No. 60/635,413, filed on Dec. 10, 2004.

(51) Int. Cl. G09B 19/02

(52) U.S. Cl. 434/188

(57) ABSTRACT

An apparatus for teaching (20) generally includes a math board (22) having a plurality of rows (24) and a plurality of columns (26). The plurality of rows and the plurality of columns form a plurality of grid cells (28). The apparatus for teaching further includes a plurality of whole numbers (30) arranged in consecutive order, such that the plurality of whole numbers are disposed within the plurality of grid cells. The plurality of grid cells are capable of being used to identify a pattern in a numerical operation.

### CROSS-REFERENCE TO RELATED APPLICATION

The present application claims the benefit of U.S. Provisional Application No. 60/635,413, filed on Dec. 10, 2004, the disclosure of which is hereby expressly incorporated by reference.

### TECHNICAL FIELD

The present disclosure relates generally to a method and apparatus for teaching, and more specifically, to a method and apparatus for teaching mathematics.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

In accordance with one embodiment of the present disclosure, an apparatus for teaching is provided. The apparatus includes a math board having a plurality of rows and a plurality of columns. The plurality of rows and the plurality of columns form a plurality of grid cells. The math board further includes a plurality of whole numbers arranged in consecutive order, such that the plurality of whole numbers are disposed within the plurality of grid cells. The plurality of grid cells are capable of being used to identify a pattern in a numerical operation.

In accordance with other embodiments of the present disclosure, a method of teaching using a math board is provided. The method includes identifying a first whole number a nearest multiple of ten to the first whole number. The method further includes determining a difference between the first whole number and the nearest multiple of ten to the first whole number. The method further includes identifying a second whole number, and performing a mathematical operation between the second whole number and the nearest multiple of ten to the first whole number to calculate a first answer. The method further includes identifying the first answer on the math board, adjusting the first answer by the difference to calculate a second answer, and identifying the second answer on the math board. The method further includes identifying a pattern on the math board between the second whole number and the second answer, and corresponding the pattern with the first whole number.

In accordance with still other embodiments of the present disclosure, a method of teaching using a math board is provided. The method includes choosing a first whole number between 0 and 9, and multiplying the first whole number by a first plurality of consecutive whole numbers to calculate a first plurality of products. The method further includes identifying the first plurality of products on the math board. The method further includes identifying a first pattern for the first plurality of products, and corresponding the first pattern with the first whole number.

### DESCRIPTION OF THE DRAWINGS

The foregoing aspects and many of the attendant advantages of this disclosure will become better understood by reference to the following detailed description, when taken in conjunction with the accompanying drawings, wherein:

FIG. 1A is a perspective view of an exemplary embodiment of a math board formed according to various aspects of the present disclosure;

FIG. 1B is a perspective view of an exemplary embodiment of math worksheets formed according to various aspects of the present disclosure;

FIG. 2 depicts the math board of FIG. 1 in use according to a first example;

FIG. 3 depicts the math board of FIG. 1 in use according to a second example;

FIG. 4 depicts the math board of FIG. 1 in use according to a third example;

FIG. 5 depicts the math board of FIG. 1 in use according to a fourth example;

FIG. 6 depicts the math board of FIG. 1 in use according to a fifth example;

FIG. 7 depicts the math board of FIG. 1 in use according to a sixth example;

FIG. 8 is the math board of FIG. 1 in use according to a seventh example;

FIG. 9A depicts the math board of FIG. 1 in use according to an eighth example;

FIG. 9B depicts a math worksheet of FIG. 1B according to a first example;

FIG. 10A depicts the math board of FIG. 1 in use according to a ninth example;

FIG. 10B depicts a math worksheet of FIG. 1B according to a second example;

FIG. 11A depicts the math board of FIG. 1 in use according to a tenth example;

FIG. 11B depicts a math worksheet of FIG. 1B according to a third example;

FIG. 12A depicts the math board of FIG. 1 in use according to a eleventh example;

FIG. 12B depicts a math worksheet of FIG. 1B according to a fourth example;

FIG. 13A depicts the math board of FIG. 1 in use according to a twelfth example;

FIG. 13B depicts a math worksheet of FIG. 1B according to a fifth example;

FIG. 14 is a first functional flow diagram indicating operation of the math board illustrated in FIG. 1;

FIG. 15 depicts the math board of FIG. 1 in use according to the flow diagram of FIG. 14;

FIG. 16 is a second functional flow diagram indicating operation of the math board illustrated in FIG. 1; and

FIG. 17 is a perspective view of a second exemplary embodiment of a math board formed according to various aspects of the present disclosure.

### DETAILED DESCRIPTION

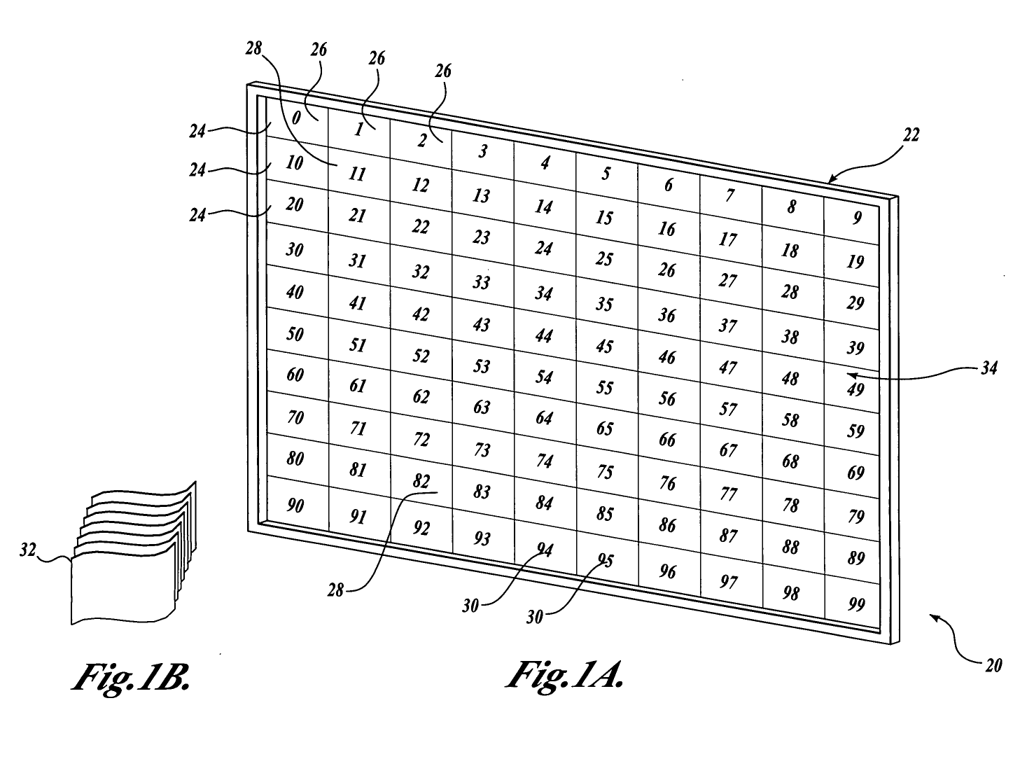

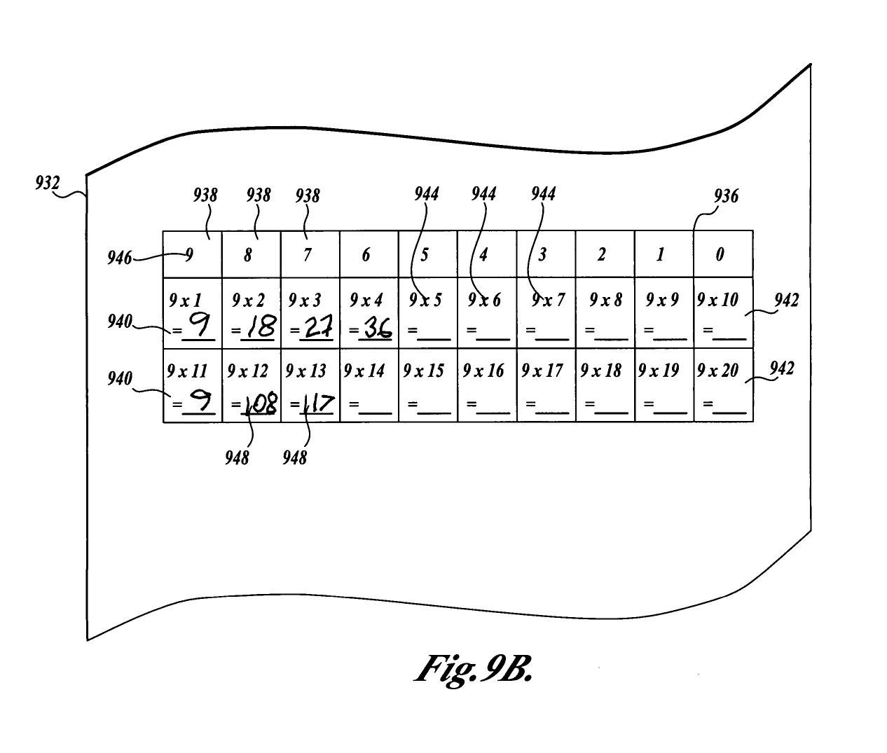

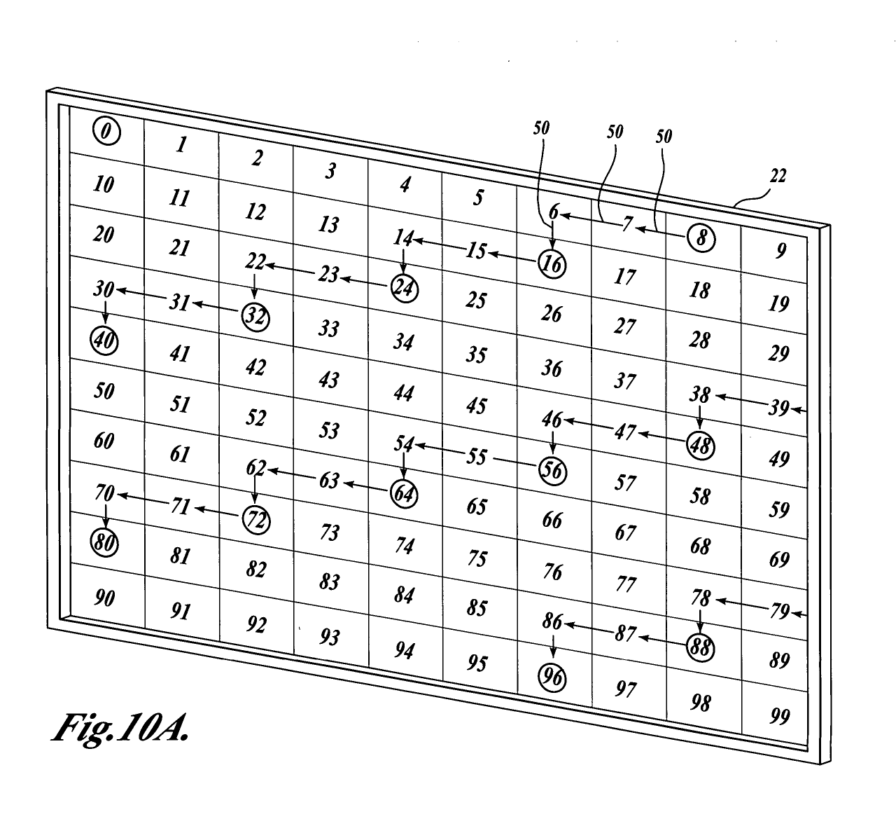

Embodiments of the present disclosure are generally directed to a method and apparatus for teaching mathematics, such as a math game. A math game 20 constructed in accordance with one embodiment of the present disclosure may be best understood by referring to FIGS 1A and 1B. The math game 20 generally includes a math board 22, which includes a plurality of rows 24 and a plurality of columns 26, wherein the plurality of rows and the plurality of columns form a plurality of grid cells 28. A plurality of whole numbers 30 arranged in consecutive order are disposed within the plurality of grid cells 28, such that the math board 22 can be used to identify patterns in numerical or mathematical operations. The math game 20 further includes math worksheets 32 for applying patterns identified on the math board 22 to teach mathematics. The math worksheets 32 are described in detail below with reference to the example math worksheets 932, 1032, 1132, 1232, and 1332 of FIGS. 9B, 10B, 11B, 12B, and 13B, respectively.

The math board 22 of the illustrated embodiment of FIG. 1A is a rectangular-shaped board, including a frame, with a plastic dry-erase panel 34. One-hundred grid cells 28 are arranged in a 10×10 grid on the panel 34 of the math board 22, with whole numbers 30 ranging from “0” to “99” disposed within one grid cell 28 each. Arranged across the first row 24 at the top of the math board 22 are whole numbers “0” through “9”, with each whole number disposed within a grid cell 28, each grid cell 28 being in a separate column 26. Arranged down the left side column 26 are whole numbers “0”, “10”, “20”, “30”, . . . “90”, with each whole number disposed within a grid cell 28, each grid cell 28 being in a separate row 24. Subsequent rows 24 on the math board 22 include whole numbers “10” through “19”, “20” through “29”, “30” through “39”, . . . and “90” through “99”. Whole numbers are selected or identified on the math board by highlighting, circling, or otherwise marking with a writing utensil, such as a dry-erase pen, or other removable indicia, such as notes, stickers, suction cups, magnets, chips, colored lenses, etc.

As discussed in greater detail below, the specific patterns in numerical operations that can be identified on the math board 22 relate to the “rule of 10” of the math game 20 of the present disclosure. The “rule of 10” is based upon base 10, including whole numbers “0” to “9”. According to the “rule of 10” of the math game 20, the math board 22 is specifically configured such that numerical operations can be related to and be patterned upon the relationship between a whole number and the number “10”.

While the whole numbers 30 in the illustrated embodiment of FIG. 1A range from “0” to “99”, it should be appreciated that other consecutive whole numbers, whether in increasing or decreasing order, are also within the scope of the disclosure. While the math board 22 of the present disclosure includes only whole numbers 30, it should be appreciated, however, that a math board configured for non-whole numbers (such as integers, decimals, or fractions) in consecutive order or for number bases other than base ten (such as base eight including whole numbers “0” to “7”) is also within the scope of the disclosure.

Regarding the math board 22, it should be appreciated that any dimensions, sizes, quantities, orientations, shapes, and designs for the math board are within the spirit and scope of the present disclosure. It should further be appreciated that the math board may be constructed from any suitable materials, including metal, wood, plastic, slate (such as a chalkboard), cardboard, paperboard (such as a board game), or paper (such as a worksheet), or any other material capable of being marked or written upon, or otherwise receiving removable indicia. It should further be appreciated that the math board of the present disclosure may be embodied in computer readable instructions stored on a computer accessible medium. In another embodiment, as discussed in detail below, a wooden math board having a plurality of holes for receiving wooden pegs to identify different whole numbers is also within the scope of the disclosure.

The math board 22 can be used for basic mathematics, such as numeric symbol identification, counting, greater than and less than relationships, etc. As discussed above, the math board 22 can also be used to identify patterns in numerical operations. Such numerical operations include mathematical operations, such as addition, subtraction, multiplication, and division, each of which will be discussed below with reference to the math board 22.

### Addition and Subtraction Examples

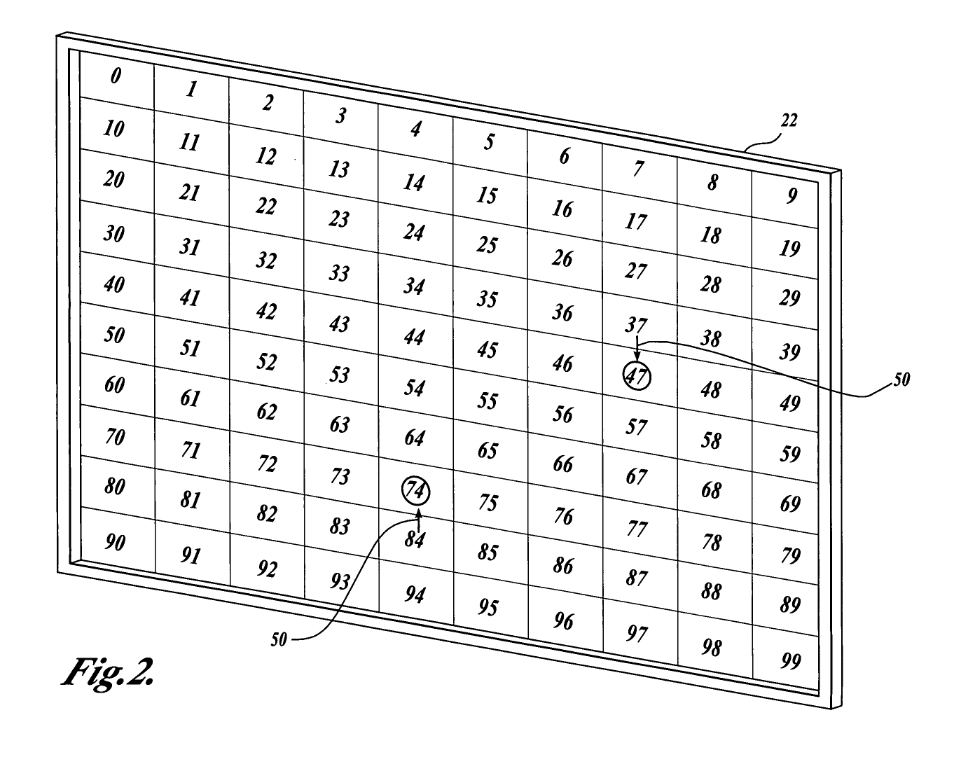

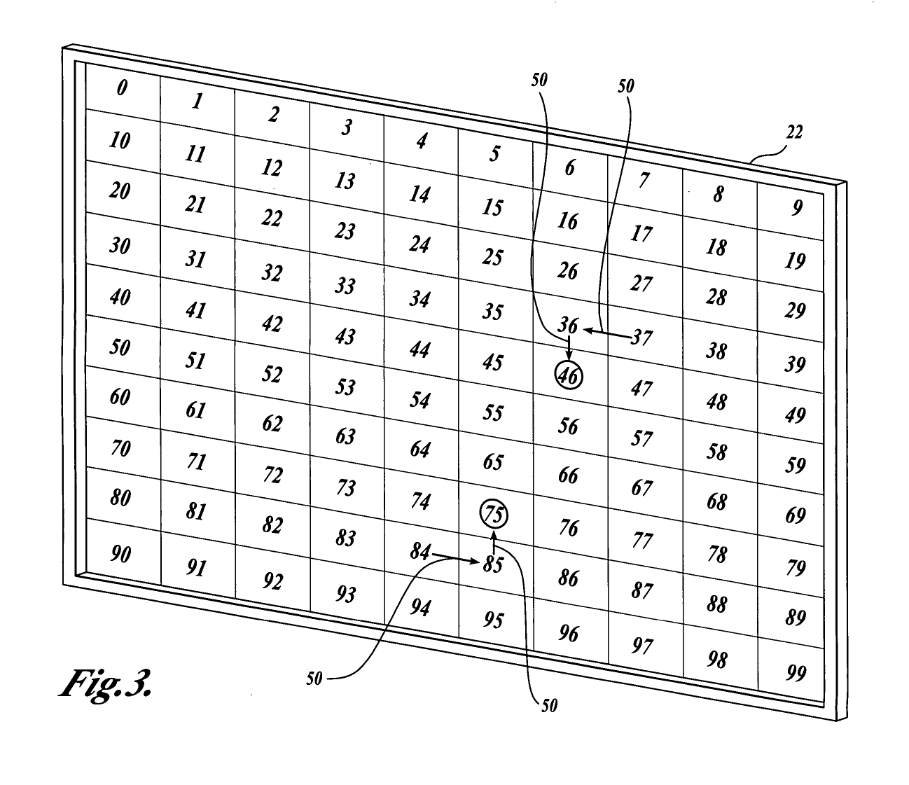

The method of using the math game for the numerical operations of addition and subtraction will now be described through a series of examples with reference to FIGS. 2-7.

### Adding and Subtraction “10”

Referring to FIG. 2, the “rule of 10” on the math board 22 states that when adding or subtracting “10” to or from a whole number, the answer will always be in the same column as the other whole number, but in either the subsequent row (for addition) or the previous row (for subtraction). Thus, adding and subtracting “10” to a whole number always follows the same pattern on the math board 22. This pattern is a one-row vertical step within the same column as the whole number.

For example, if a user identifies a whole number N=37 on the math board, and adds 10 to that number, the answer A=47 is exactly one row down from N=37 on the math board, as indicated by arrow 50 in FIG. 2. If a user identifies a whole number N=84 on the math board, and subtracts 10 from that number, the answer A=74 is exactly one row up from N=84, as indicated by arrow 50 in FIG. 2.

In addition, when adding or subtracting any multiples of “10” to or from a whole number, a similar pattern is established. The pattern is a vertical step within the same column as the whole number, wherein the number of rows stepped depends upon the multiple of ten. To determine the number of rows stepped, the multiple of ten is divided by “10”. For example, when adding or subtracting “20”, the answer will be in the same column, but two subsequent rows down (for addition) or two previous rows up (for subtraction), because 20/10=2. When adding or subtracting “30”, the answer will be in the same column, but three subsequent rows down (for addition) or three previous rows up (for subtraction), because 30/10=3, and so on.

In general, when adding or subtracting a whole number that is close but not equal to “10”, the vertical step on the math board 22 will also be accompanied by a horizontal step(s), wherein the number of horizontal steps depends on the difference between the whole number and the number “10”. The direction of the horizontal step(s) will be determined by whether the whole number is greater than or less than “10”. For example, as discussed in detail below, adding “8” will require two horizontal steps to the left and one vertical step down. Likewise, subtracting “8” will require two horizontal steps to the right and one vertical step up. Adding or subtracting whole numbers greater than “10” will require a vertical step, as well as a horizontal step in the opposite direction of whole numbers less than “10”. For example, as described in detail below, adding “11” will require one horizontal step to the right and one vertical step down.

### Adding and Subtracting “9”

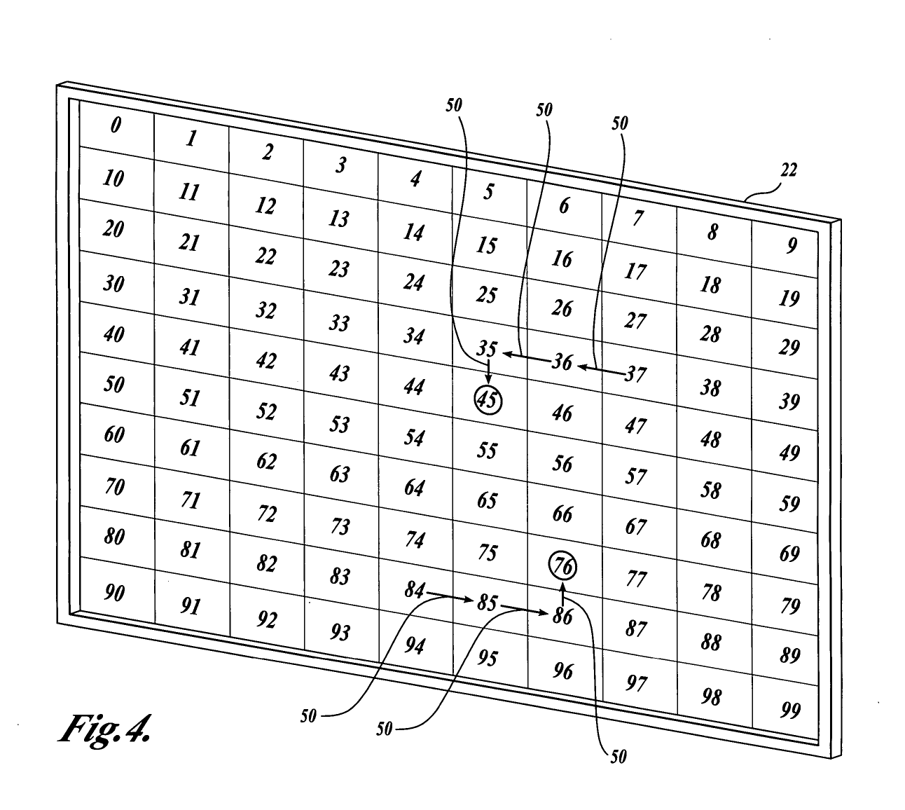

Referring to FIG. 3, adding and subtracting “9” on the math board 22 is similar to the rule for adding and subtracting “10”, but the pattern for adding and subtracting “9” includes a horizontal step as well as a vertical step because “9” is one less than “10”. Thus, when adding “9” to a whole number, the pattern for the answer will be one column to the left and one row down from the whole number. When subtracting “9” from a whole number, the pattern for the answer will be one column to the right and one row up from the whole number.

For example, if a user identifies a whole number N=37 on the math board, and adds “9” to that number, the answer A=46 is exactly one column to the left and one row down from N=37 on the math board, as indicated by arrows 50 in FIG. 3. If a user identifies a whole number N=84 on the math board, and subtracts “9” from that number, the answer A=75 is exactly one column to the right and one row up from N=84, as indicated by arrows 50 in FIG. 3.

### Adding and Subtraction “8”

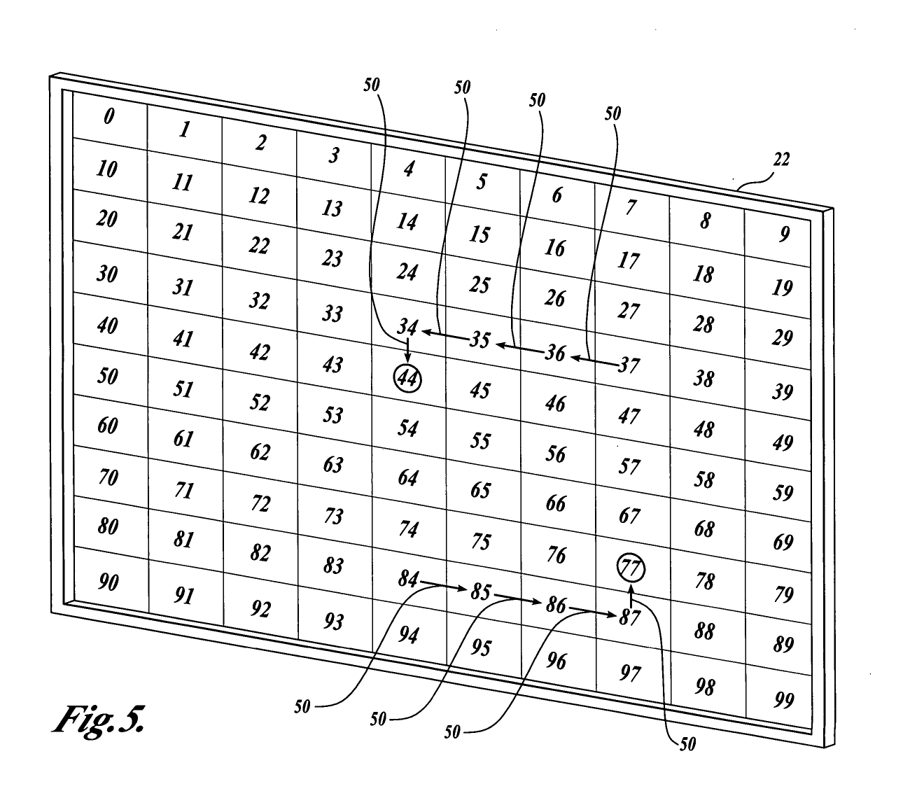

Referring to FIG. 4, adding and subtracting “8” on the math board 22 is similar to adding and subtracting “9”, but the pattern for adding and subtracting “8” includes two horizontal steps as well as a vertical step because “8” is two less than “10”. Thus, when adding “8” to a whole number, the pattern for the answer will be two columns to the left and one row down from the whole number. When subtracting “8” from a whole number, the pattern for the answer will be two columns to the right and one row up from the whole number.

For example, if a user identifies a whole number N=37 on the math board, and adds “8” to that number, the answer A=45 is exactly two columns to the left and one row down from N=37 on the math board, as indicated by arrows 50 in FIG. 4. If a user identifies a whole number N=84 on the math board, and subtracts “8” from that number, the answer A=76 is exactly two columns to the right and one row up from N=84, as indicated by arrows 50 in FIG. 4.

### Adding and Subtraction “7”

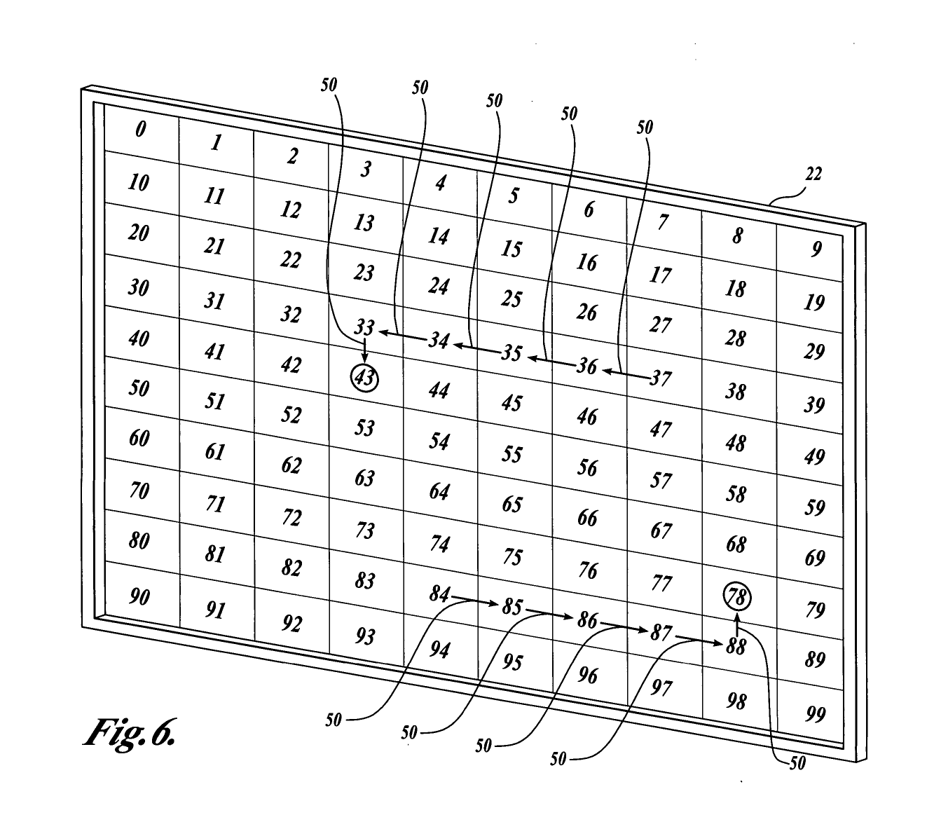

Referring to FIG. 5, adding and subtracting “7” on the math board 22 is similar to adding and subtracting “8”, but the pattern for adding and subtracting “7” includes three horizontal steps as well as a vertical step because “7” is three less than “10”. Thus, when adding “7” to a whole number, the pattern for the answer will be three columns to the left and one row down from the whole number. When subtracting “7” from a whole number, the pattern for the answer will be three columns to the right and one row up from the whole number.

For example, if a user identifies a whole number N=37 on the math board, and adds “7” to that number, the answer A=44 is exactly three columns to the left and one row down from N=37 on the math board, as indicated by arrows 50 in FIG. 5. If a user identifies a whole number N=84 on the math board, and subtracts “7” from that number, the answer A=77 is exactly three columns to the right and one row up from N=84, as indicated by arrows 50 in FIG. 5.

### Adding and Subtraction “6”

Referring to FIG. 6, adding and subtracting “6” on the math board 22 is similar to adding and subtracting “7”, but the pattern for adding and subtracting “6” includes four horizontal steps as well as a vertical step because “6” is four less than “10”. Thus, when adding “6” to a whole number, the pattern for the answer will be four columns to the left and one row down from the whole number. When subtracting “6” from a whole number, the pattern for the answer will be four columns to the right and one row up from the whole number.

For example, if a user identifies a whole number N=37 on the math board, and adds “6” to that number, the answer A=43 is exactly four columns to the left and one row down from N=37 on the math board, as indicated by arrows 50 in FIG. 6. If a user identifies a whole number N=84 on the math board, and subtracts “6” from that number, the answer A=78 is exactly four columns to the right and one row up from N=84, as indicated by arrows 50 in FIG. 6.

Similar patterns can also be established for adding and subtracting numbers greater than “10” (such as “11”, “12”, “13”, and “14”), as follows.

### Adding and Subtraction 11

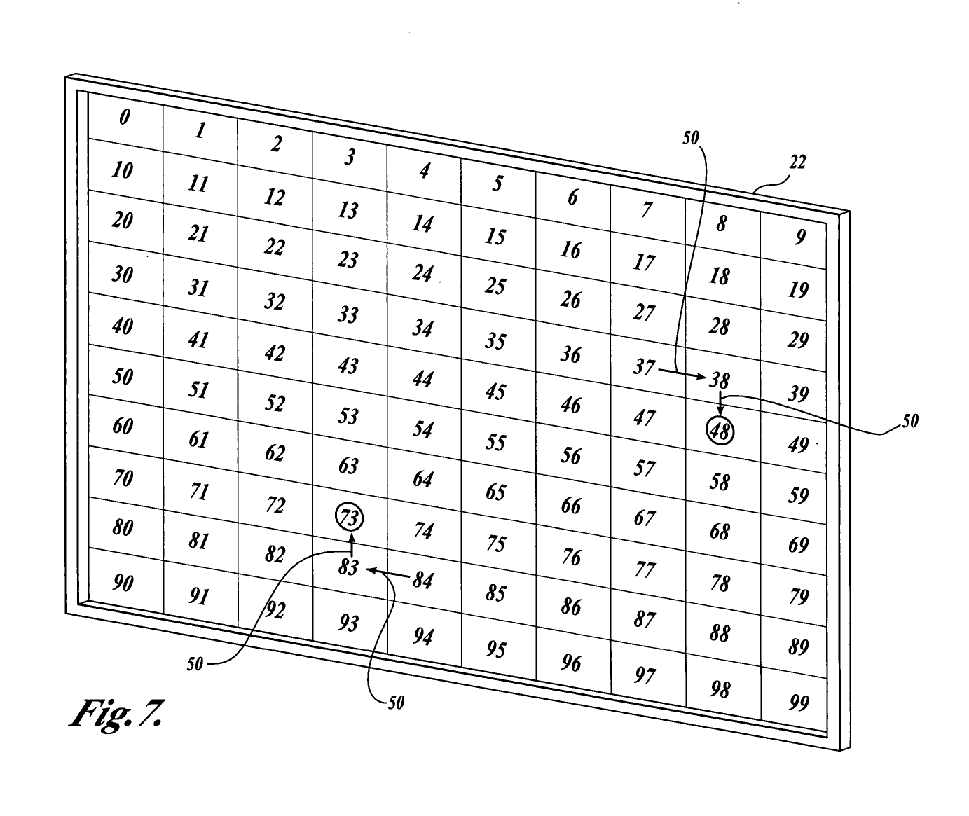

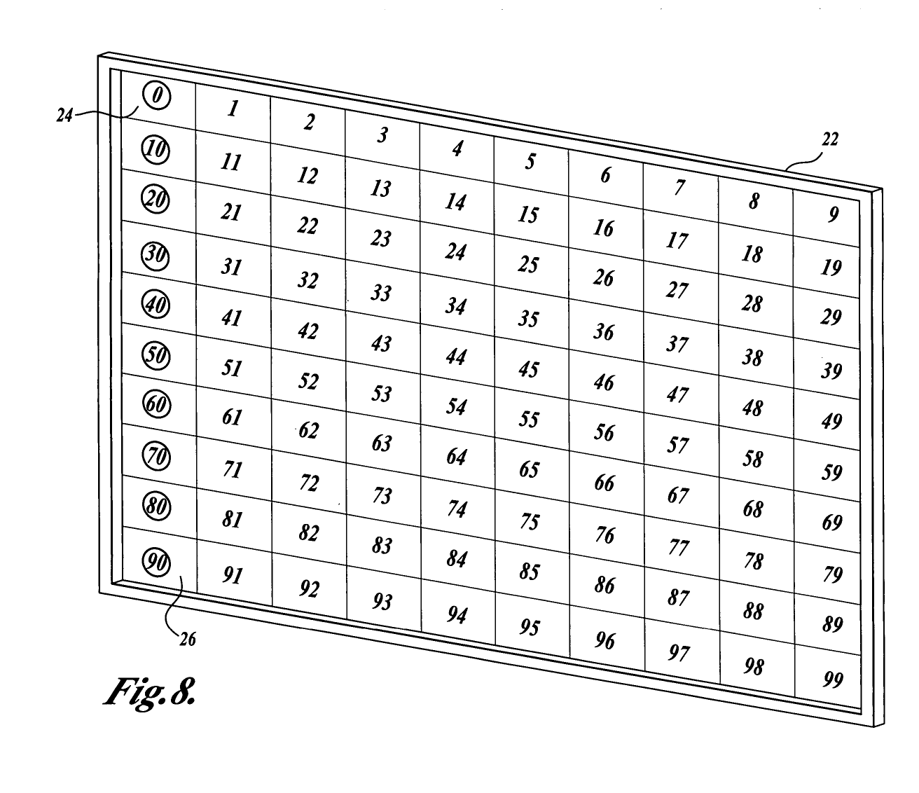

Referring to FIG. 7, adding and subtracting “11” on the math board 22 is similar to adding and subtracting “10”, but the pattern for adding and subtracting “11” includes a horizontal step as well as a vertical step because “11” is one more than “10”. Thus, when adding “11” to a whole number, the pattern of the answer will be one column to right and one row down from the whole number. When subtracting “11” from a whole number, the pattern for the answer will be one column to the left and one row up from the whole number.

For example, if a user identifies a whole number N=37 on the math board, and adds “11” to that number, the answer A=48 is exactly one column to the right and one row down from N=37 on the math board, as indicated by arrows 50 in FIG. 7. If a user identifies a whole number N=84 on the math board, and subtracts “11” from that number, the answer A=73 is exactly one column to the left and one row up from N=84, as indicated by arrows 50 in FIG. 7.

Similar patterns can be established for adding and subtracting numbers such as “12”, “13”, “14”, etc. Therefore, the method of using the math game can be used to identify patterns generally directed to whole numbers based on their relationship to the number “10”, and their use in mathematical operations on the math board to aid in teaching mathematics.

In addition, similar patterns can be established for adding and subtracting any whole numbers having “9”, “8”, “7”, “6”, “5”, “4”, “3”, “2”, or “1” in the ones place, such “19”, “29”, “39”, and so on, by identifying the nearest multiple of ten and following the same patterns established above.

### Multiplication and Division Examples

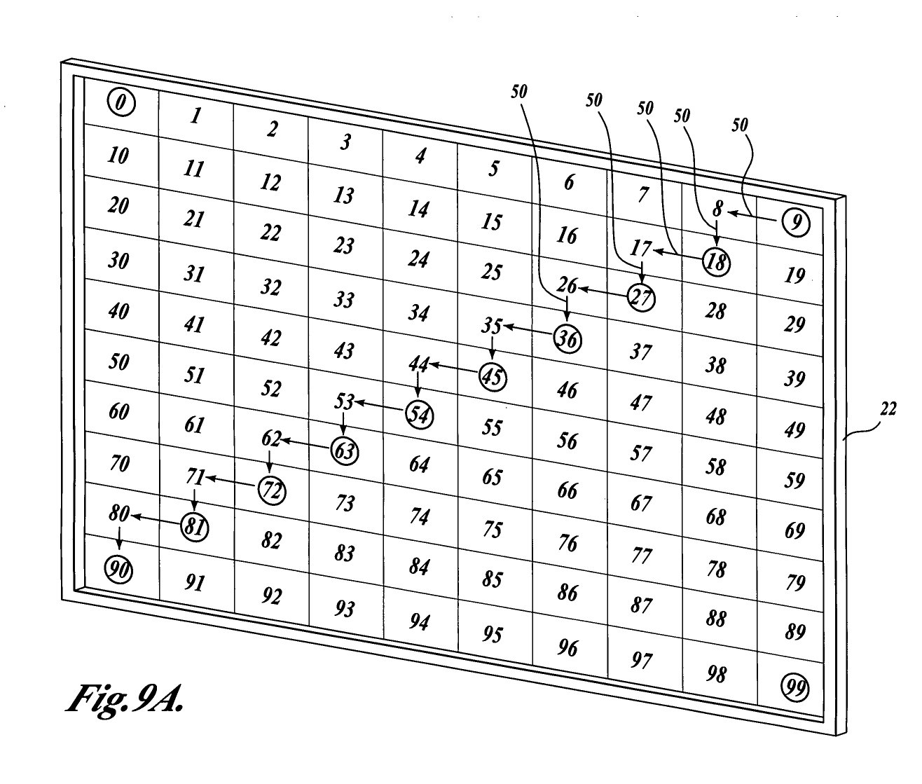

The math game described above can further be used to teach multiplication and division. The method of using the math game for the numerical operation of multiplication will now be described through a series of examples with reference to FIGS. 8-13. Because the method of using the math game for the numerical operation of division is well-known as the opposite operation of that for multiplication, the method of using the math game for division will not be described in further detail.

### Multiplying by “10”

Referring to FIG. 8, when multiplying any whole number by “10” on the math board 22, the answer will be in the first column 26 on the math board. For example, when multiplying 10×1, the answer A=10, which can be identified in the first column 26 on the math board 22. When multiplying 10×2, the answer A=20, which is one row down from “10” in the first column on the math board 22. When multiplying 10×3, the answer A=30, which is one row down from “20” in the first column 26 on the math board 22, and so on. Additional equations for multiplying by “10” are depicted in Table 1 that follows.

TABLE 1

| | |
|---|---|
| 10 × 0 = | 0 |
| 10 × 1 = | 10 |
| 10 × 2 = | 20 |
| 10 × 3 = | 30 |
| 10 × 4 = | 40 |
| 10 × 5 = | 50 |
| 10 × 6 = | 60 |
| 10 × 7 = | 70 |
| 10 × 8 = | 80 |
| 10 × 9 = | 90 |

The pattern on the math board 22 for multiplying by “10” is illustrated in FIG. 8, and can be described as a vertical pattern beginning in the first row of the first column of the math board 22 and traveling down one row (without a horizontal component) with each consecutive whole number increase.

In general, when multiplying by a whole number that is close but not equal to “10”, each vertical step on the math board 22 will be accompanied by a horizontal step(s), wherein the number of horizontal steps depends on the difference between the whole number and the number “10”. The direction of the horizontal step(s) will be determined by whether the whole number is greater than or less than “10”. For example, as discussed in detail below, multiplying by “8” will require two horizontal steps to the left for each vertical step down. Likewise, multiplying by “7” will require three horizontal steps to the left for each vertical step down. Multiplying by whole numbers greater than “10” will require a horizontal step in the opposite direction. For example, as described in detail below, multiplying by “11” will require one horizontal step to the right for each vertical step down.

### Multiplying by “9”

Referring to FIG. 9A, multiplying by “9” on the math board 22 is similar to multiplying “10”, but the pattern for multiplying by “9” includes a horizontal step for each vertical step because “9” is one less than “10”. For example, when multiplying 9×1, the answer is A=9, which can be identified on the math board 22. When multiplying 9×2, the answer is A=18, which is one column to the left and one row down from “9” on the math board 22. When multiplying 9×3, the answer is A=27, which is one column to the left and one row down from “18 ” on the math board 22, and so on. Additional equations for multiplying by “9” are depicted in Table 2 that follows.

TABLE 2

| | |
|---|---|
| 9 × 0 = | 0 |
| 9 × 1 = | 9 |
| 9 × 2 = | 18 |
| 9 × 3 = | 27 |
| 9 × 4 = | 36 |
| 9 × 5 = | 45 |
| 9 × 6 = | 54 |
| 9 × 7 = | 63 |
| 9 × 8 = | 72 |
| 9 × 9 = | 81 |
| 9 × 10 = | 90 |
| 9 × 11 = | 99 |

The pattern on the math board 22 for multiplying by “9” is illustrated in FIG. 9A, and can be described as a diagonal pattern beginning in the first row and the tenth column of the math board 22, and traveling down one row and to the left one column on the math board 22 for each consecutive whole number increase.

With reference to FIG. 1B, as mentioned above, the math game 20 further includes math worksheets 32. The worksheets 32 are configured to correspond with the patterns established for multiplying by certain whole numbers (e.g., the numbers “9”, “8”, “7”, etc.) on the math board 22. It should be appreciated that all of the following multiplication examples can also be used to teach division.

Referring to FIG. 9B, there is shown an example math worksheet 932 having a math table 936 specifically configured for the number “9”. The math table 936 corresponds with the pattern generated on the math board 22 in FIG. 9A for multiplying by the number “9”, and includes ten columns 938 and two rows 940 of table cells 942, filled with multiplying by “9” equations. The number of columns 938 will remain the same in the math table 936, because (as discussed in detail below) the products generated when multiplying by “9” will always end in the same ten numbers in the following pattern: “9”, “8”, “7”, “6”, “5”, “4”, “3”, “2”, “1”, and “0”. However, the number of rows 940 for multiplying by “9” can theoretically continue on to infinity, because the number of products that can be generated when multiplying by “9” is infinite.

The multiplying by “9” equations 944 are arranged in consecutive increasing order from left to right across each row 940 beginning at the first row. For example, the first equation is 9×1, the second equation is 9×2, and so on. The column headings 946 include “9”, “8”, “7”, “6”, “5”, “4”, “3”, “2”, “1”, and “0”.

Some of the products 948 for each of the multiplying by “9” equations have been filled in after the equations 944 to show how the user would complete the math worksheet 932. By referring to these products 948, the reader will notice that each of the ten column headings 946 corresponds with the numerals in the ones place of the products in the table cells 942 below the headings 946.

As discussed in detail above, the pattern for determining multiples of “9” in FIG. 9A is one horizontal step to the left for each vertical step down on the math board 22, as shown by arrows 50. Isolating the horizontal step, the ones place goes back one whole number with each multiple continually on a number line from “0” to “9” (e.g., 9, 18, 27, 36, 45, 54, 63, 73, 81, 90, 99, and so on). Thus, the user can use the horizontal pattern generated on the math board 22 in FIG. 9A for multiplying by the number “9” to fill in the column headings 946 on the math table 936 (from left to right) as well as the products 948 for “9s” multiplication on the math worksheet 932 of FIG. 9B.

Using this horizontal step pattern of the math worksheet 932 to establish the ones place for infinite rows 940 (and thus infinite products 948), the user can calculate products 948 beyond those identified on the math board 22 of FIG. 9A (i.e., products greater than 99), for example 9×12=108, 9×13=117, etc. (see FIG. 9B).

In addition, the math table 936 of the math worksheet 932 maybe be configured for more advanced multiplication learning. As a non-limiting example, one or more cells 942 of the table 936 may be blocked out, as follows in example Table 3 below, such that the user cannot simply calculate the next product 948 in the math table 936 by adding “9” to the product 948 of the previous cell 942. It should be appreciated that other designs and configurations for blocking out cells 942 of the math table 936 (including blocking our column headings 946) are also within the scope of the present disclosure. Moreover, it should be appreciated that the math table 936 can also be configured to include multiplication by “9” equations 944 in random, non-sequential, or non-patterned order.

TABLE 3

| | | | | | | | | | |
|---|---|---|---|---|---|---|---|---|---|
| 9 | 8 | 7 | 6 | 5 | 4 | 3 | 2 | 1 | 0 |

| | | | | | | | | | |
|---|---|---|---|---|---|---|---|---|---|
| 9 + 1 = | 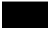 | 9 + 3 = | 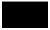 | 9 + 5 = | 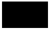 | 9 + 7 = | 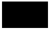 | 9 + 9 = | 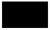 |
| 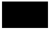 | 9 + 12 = | 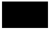 | 9 + 14 = | 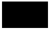 | 9 + 16 = | 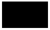 | 9 + 18 = | 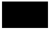 | 9 + 20 = |

### Multiplying by “8”

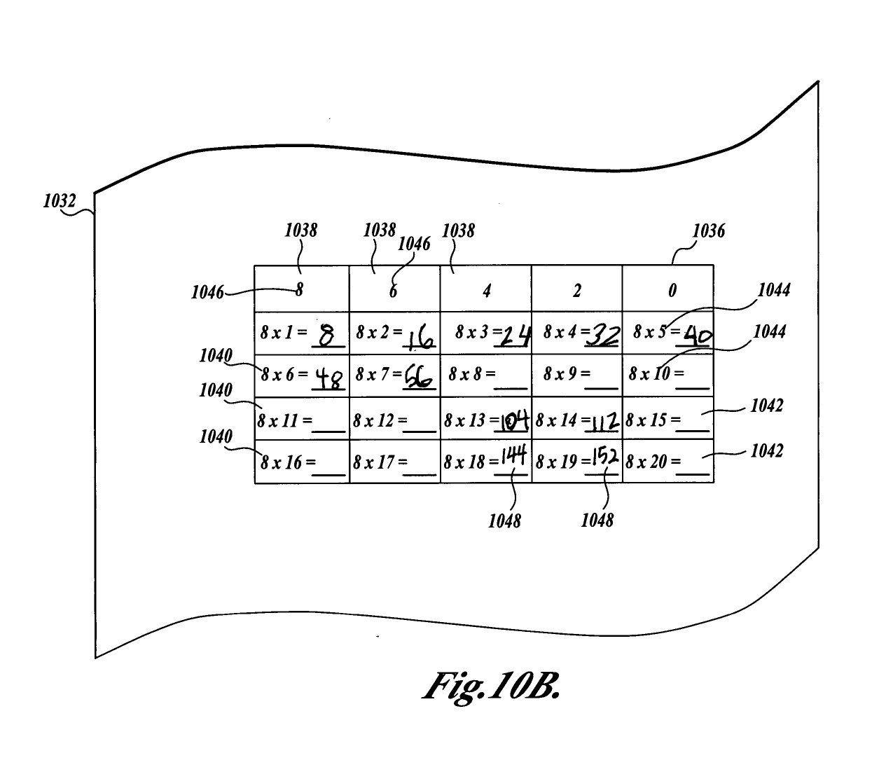

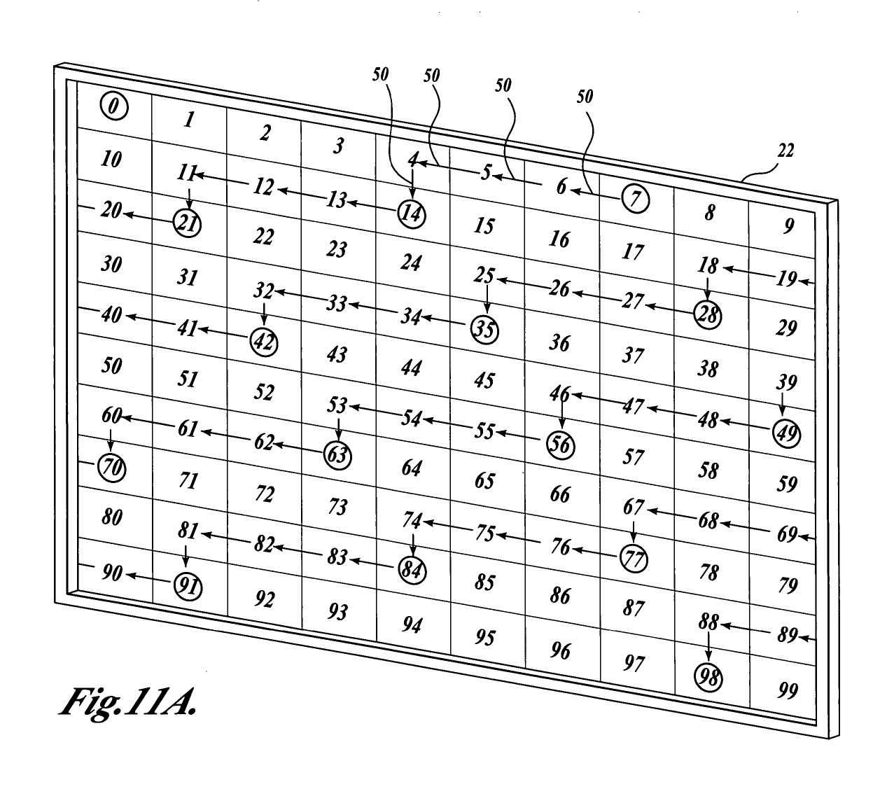

Referring to FIG. 10A, multiplying by “8” on the math board 22 is similar to multiplying by “9”, but it includes two horizontal steps for each vertical step because “8” is two less than “10”. For example, when multiplying 8×1, the answer is A=8. When multiplying 8×2, the answer is A=16, which is two columns to the left and one row down from “8” on the math board 22. When multiplying 8×3, the answer is A=24, which is two columns to the left and one row down from “16” on the math board 22, and so on. Additional equations for multiplying by “8” are depicted in Table 4 that follows.

TABLE 4

| | |
|---|---|
| 8 × 0 = | 0 |
| 8 × 1 = | 8 |
| 8 × 2 = | 16 |
| 8 × 3 = | 24 |
| 8 × 4 = | 32 |
| 8 × 5 = | 40 |
| 8 × 6 = | 48 |
| 8 × 7 = | 56 |
| 8 × 8 = | 64 |
| 8 × 9 = | 72 |
| 8 × 10 = | 80 |
| 8 × 11 = | 88 |
| 8 × 12 = | 96 |

The pattern on the math board 22 for multiplying by “8” is illustrated in FIG. 10A, and is thus associated with the number “8”.

Referring to FIG. 10B, there is shown an example math worksheet 1032 having a math table 1036 specifically configured for the number “8”. The math table 1036 corresponds with the pattern generated on the math board 22 in FIG. 10A for multiplying by the number “8”, and includes five columns 1038 and four rows 1040 of table cells 1042, filled with multiplying by “8” equations. The number of columns 1038 will remain the same in the math table 1036, because (as discussed in detail below) the products generated when multiplying by “8” will always end in the same five numbers in the following pattern: “8”, “6”, “4”, “2”, and “0”. However, the number of rows 1040 for multiplying by “8” can theoretically continue on to infinity, because the number of products that can be generated when multiplying by “8” is infinite.

Still referring to the math worksheet of FIG. 10B, the multiplying by “8” equations 1044 are arranged in consecutive increasing order from left to right across each row 1040 beginning at the first row 1040 of the math table 1036. For example, the first equation is 8×1, the second equation is 8×2, and so on. The column headings 1046 include “8”, “6”, “4”, “2”, and “0”.

Some of the products 1048 for each of the multiplying by “8” equations have been filled in after the equations 1044 to show how the user would complete the math worksheet 1032. By referring to these products 1048, the reader will notice that each of the five column headings 1046 corresponds with the numerals in the ones place of the products 1048 in the table cells 1042 below the headings 1046.

As discussed in detail above, the pattern for determining multiples of “8” in FIG. 10A is two horizontal steps to the left for each vertical step down on the math board 22, as shown by arrows 50. Isolating the horizontal steps, the ones place goes back two whole numbers with each multiple continually on a number line from “0” to “9” (e.g., 8, 16, 24, 32, 40, 48 and so on). Thus, the user can use the horizontal pattern generated on the math board 22 in FIG. 10A for multiplying by the number “8” to fill in the column headings 1046 of the math table 1036 (from left to right) as well as the products 1048 for “8s” multiplication on the math worksheet 1032 of FIG. 10B.

Using this horizontal step pattern of the math worksheet 1032 to establish the ones place for infinite rows 1040 (and thus infinite products 1048), the user can calculate products 1048 beyond those identified on the math board 22 of FIG. 10A (i.e., products greater than 99), for example 8×13=104, 8×14=112, etc. (see FIG. 10B). In addition, as detailed above with respect to multiplication by “9s”, the math worksheet 1032 for multiplication by “8s” also may be configured for more advanced multiplication learning.

### Multiplying by “7”

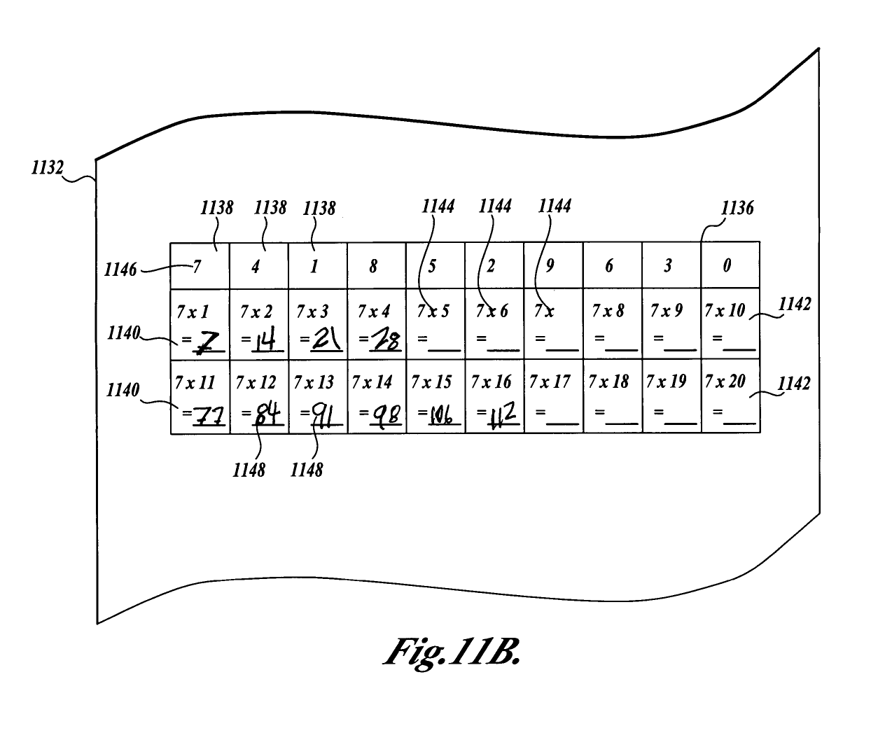

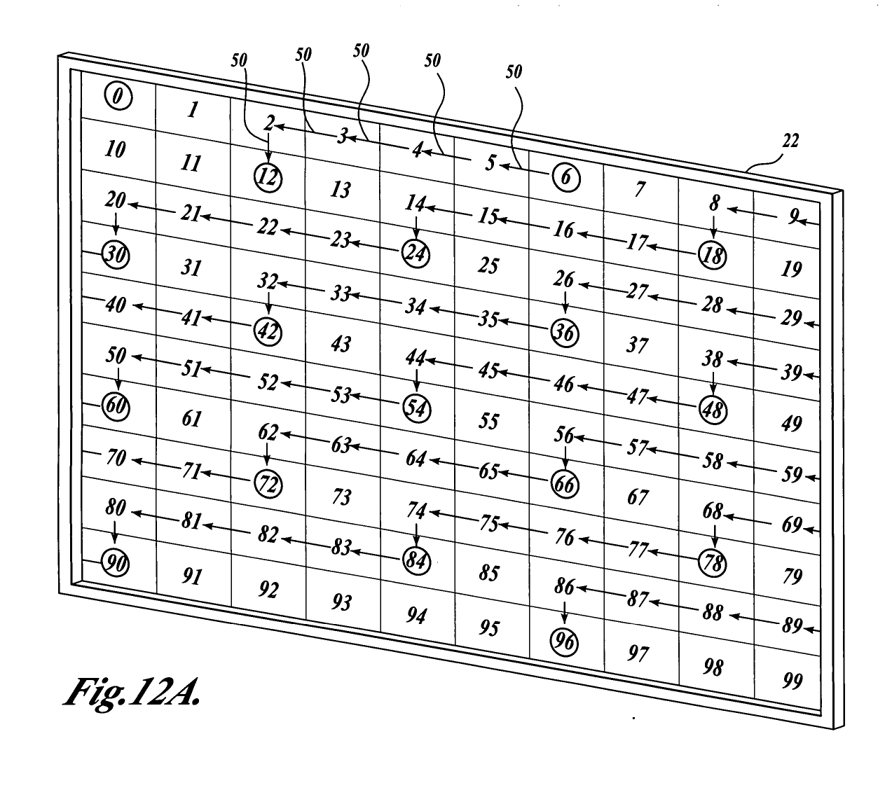

Referring to FIG. 11A, multiplying by “7” on the math board 22 is similar to multiplying by “8”, but it includes three horizontal steps as well as a vertical step because “7” is three less than “10”. For example, when multiplying 7×1, the answer is A=7. When multiplying 7×2, the answer is A=14, which is three columns to the left and one row down from “7” on the math board 22. When multiplying 7×3, the answer is A=21, which is three columns to the left and one row down from “14” on the math board 22, and so on. Additional equations for multiplying by “7” are depicted in Table 5 that follows.

TABLE 5

| | |
|---|---|
| 7 × 0 = | 0 |
| 7 × 1 = | 7 |
| 7 × 2 = | 14 |
| 7 × 3 = | 21 |
| 7 × 4 = | 28 |
| 7 × 5 = | 35 |
| 7 × 6 = | 42 |
| 7 × 7 = | 49 |
| 7 × 8 = | 56 |
| 7 × 9 = | 63 |
| 7 × 10 = | 70 |
| 7 × 11 = | 77 |
| 7 × 12 = | 84 |
| 7 × 13 = | 91 |
| 7 × 14 = | 98 |

The pattern on the math board 22 for multiplying by “7” is illustrated in FIG. 11A, and is thus associated with the number “7”.

Referring to FIG. 11B, there is shown an example math worksheet 1132 having a math table 1136 specifically configured for the number “7”. The math table 1136 corresponds with the pattern generated on the math board 22 in FIG. 11A for multiplying by the number “7”, and includes ten columns 1138 and two rows 1140 of table cells 1142, filled with multiplying by “7” equations. The number of columns 1138 will remain the same in the math table 1136, because (as discussed in detail below) the products generated when multiplying by “7” will always end in the same ten numbers in the following pattern: “7”, “4”, “1”, “8”, “5”, “2”, “9”, “6”, “3”, and “0”. However, the number of rows 1140 for multiplying by “7” can theoretically continue on to infinity, because the number of products that can be generated when multiplying by “7” is infinite.

Still referring to the math worksheet of FIG. 11B, the multiplying by “7” equations 1144 are arranged in consecutive increasing order from left to right across each row 1140 beginning at the first row 1140 of the math table 1136. For example, the first equation is 7×1, the second equation is 7×2, and so on. The column headings 1146 include “7”, “4”, “1”, “8”, “5”, “2”, “9”, “6”, “3”, and “0”.

Some of the products 1148 for each of the multiplying by “7” equations have been filled in after the equations 1144 to show how the user would complete the math worksheet 1132. By referring to these products 1148, the reader will notice that each of the ten column headings 1146 corresponds with the numerals in the ones place of the products 1148 in the table cells 1142 below the headings 1146.

As discussed in detail above, the pattern for determining multiples of “7” in FIG. 11A is three horizontal steps to the left for each vertical step down on the math board 22, as shown by arrows 50. Isolating the horizontal steps, the ones place goes back three whole numbers with each multiple continually on a number line from “0” to “9” (e.g., 7, 14, 21, 28, 35, 42, 49, 56, 63, 70, 77, and so on). Thus, the user can use the horizontal pattern generated on the math board 22 in FIG. 11A for multiplying by the number “7” to fill in the column headings 1146 of the math table 1136 (from left to right) as well as the products 1148 for “7s” multiplication on the math worksheet 1132 of FIG. 11B.

Using this horizontal step pattern of the math worksheet 1132 to establish the ones place for infinite rows 1140 (and thus infinite products 1148), the user can calculate products 1148 beyond those identified on the math board 22 of FIG. 11A (i.e., products greater than 99), for example 7×15=105, 7×16=112, etc. (see FIG. 11B). In addition, as detailed above with respect to multiplication by “9s”, the math worksheet 1132 for multiplication by “7s” also may be configured for more advanced multiplication learning.

### Multiplying by “6”

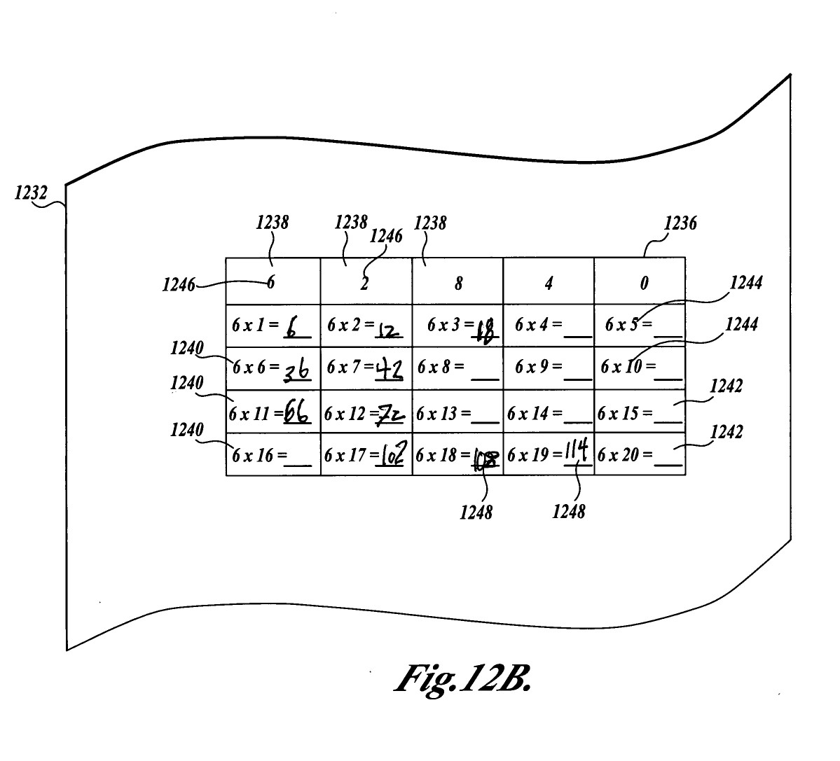

Referring to FIG. 12A, multiplying by “6” on the math board 22 is similar to multiplying by “7”, but it includes four horizontal steps as well as a vertical step because “6” is four less than “10”.

For example, when multiplying 6×1, the answer is A=6. When multiplying 6×2, the answer is A=12, which is four columns to the left and one row down from “6” on the math board 22. When multiplying 6×3, the answer is A=18, which is four columns to the left and one row down from “12” on the math board 22, and so on. Additional equations for multiplying by “6” are depicted in Table 6 that follows.

TABLE 6

| | |
|---|---|
| 6 × 0 = | 0 |
| 6 × 1 = | 6 |
| 6 × 2 = | 12 |
| 6 × 3 = | 18 |
| 6 × 4 = | 24 |
| 6 × 5 = | 30 |
| 6 × 6 = | 36 |
| 6 × 7 = | 42 |
| 6 × 8 = | 48 |
| 6 × 9 = | 54 |
| 6 × 10 = | 60 |
| 6 × 11 = | 66 |
| 6 × 12 = | 72 |
| 6 × 13 = | 78 |
| 6 × 14 = | 84 |
| 6 × 15 = | 90 |
| 6 × 16 = | 96 |

The pattern on the math board 22 for multiplying by “6” is illustrated in FIG. 12A, and is thus associated with the number “6”.

Referring to FIG. 12B, there is shown an example math worksheet 1232 having a math table 1236 specifically configured for the number “6”. The math table 1236 corresponds with the pattern generated on the math board 22 in FIG. 12A for multiplying by the number “6”, and includes five columns 1238 and four rows 1240 of table cells 1242, filled with multiplying by “6” equations. The number of columns 1238 will remain the same in the math table 1236, because (as discussed in detail below) the products generated when multiplying by “6” will always end in the same five numbers in the following pattern: “6”, “2”, “8”, “4”, and “0”. However, the number of rows 1240 for multiplying by “6” can theoretically continue on to infinity, because the number of products that can be generated when multiplying by “6” is infinite.

Still referring to the math worksheet of FIG. 12B, the multiplying by “6” equations 1244 are arranged in consecutive increasing order from left to right across each row 1240 beginning at the first row 1240 of the math table 1236. For example, the first equation is 6×1, the second equation is 6×2, and so on. The column headings 1246 include “6”, “2”, “8”, “4”, and “0”.

Some of the products 1248 for each of the multiplying by “6” equations have been filled in after the equations 1244 to show how the user would complete the math worksheet 1232. By referring to these products 1248, the reader will notice that each of the five column headings 1246 corresponds with the numerals in the ones place of the products 1248 in the table cells 1242 below the headings 1246.

As discussed in detail above, the pattern for determining multiples of “6” in FIG. 12A is four horizontal steps to the left for each vertical step down on the math board 22, as shown by arrows 50. Isolating the horizontal steps, the ones place goes back four whole numbers with each multiple continually on a number line from “0” to “9” (e.g., 6, 12, 18, 24, 30, 36 and so on). Thus, the user can use the horizontal pattern generated on the math board 22 in FIG. 12A for multiplying by the number “6” to fill in the column headings 1246 of the math table 1236 (from left to right) as well as the products 1248 for “6s” multiplication on the math worksheet 1232 of FIG. 12B.

Using this horizontal step pattern of the math worksheet 1232 to establish the ones place for infinite rows 1240 (and thus infinite products 1248), the user can calculate products 1248 beyond those identified on the math board 22 of FIG. 12A (i.e., products greater than 99), for example 6×17=102, 6×18=108, etc. (see FIG. 12B). In addition, as detailed above with respect to multiplication by “9s”, the math worksheet 1232 for multiplication by “6s” also may be configured for more advanced multiplication learning.

Many math teachers find that patterns are not necessary to help teach users to multiply numbers less than “6” (such as “5”, “4”, “3”, “2”, and “1”), because many math users are able to grasp the multiplication tables for these smaller numbers with greater ease than the higher numbers (such as “6”, “7”, “8”, and “9”). It should be appreciated, however, that patterns for these smaller numbers are within the scope of the present disclosure.

In addition, similar patterns can be established for multiplying numbers greater than “10” (such as “11”, “12”, “13”, “14”, “15” and so on). While multiplying by “11” is described in greater detail below, it should be appreciated that patterns for numbers “12”, “13”, “14”, and “15” are also within the scope of the invention. Therefore, the method of using the math game can be used to identify patterns and is generally directed to any whole numbers, their relationship to the number “10”, and their use in performing numerical operations on the math board. In addition, all of the multiplication examples can also be used to teach division.

### Multiplying by “11”

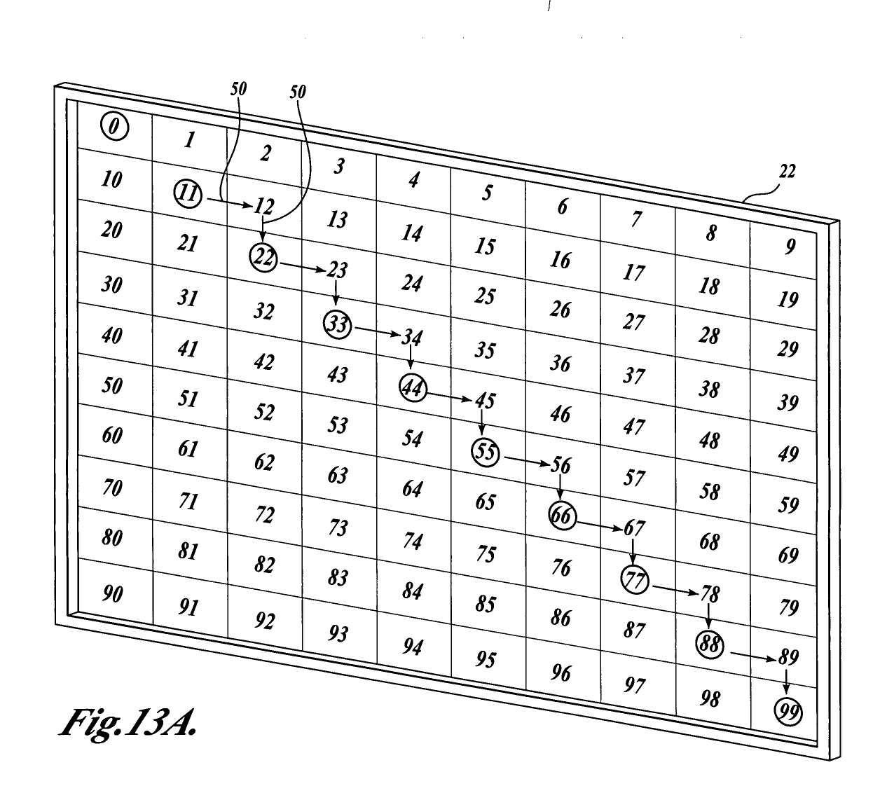

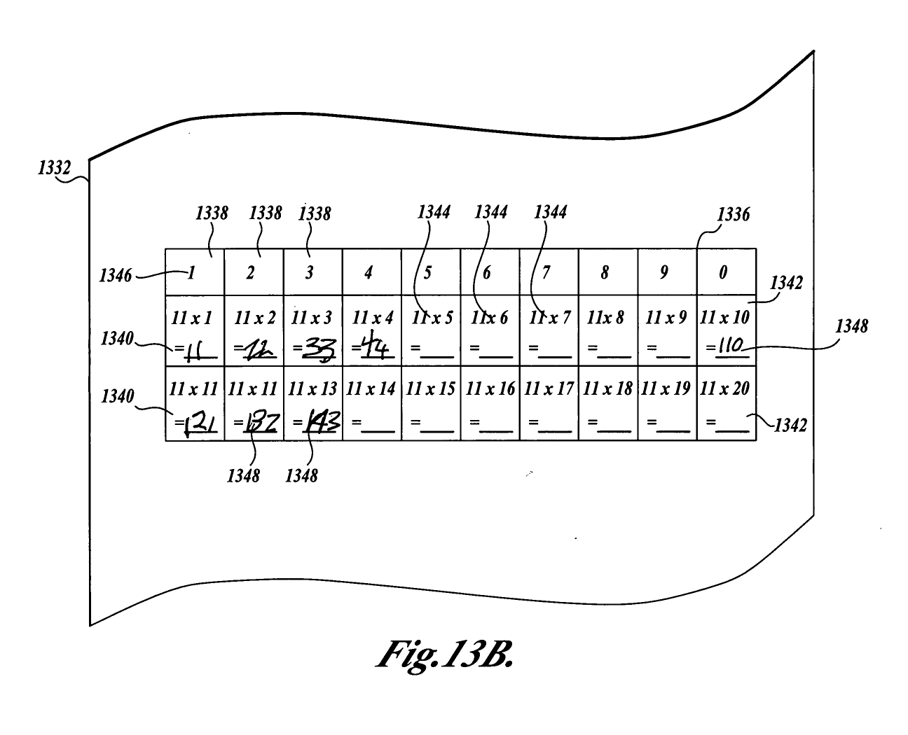

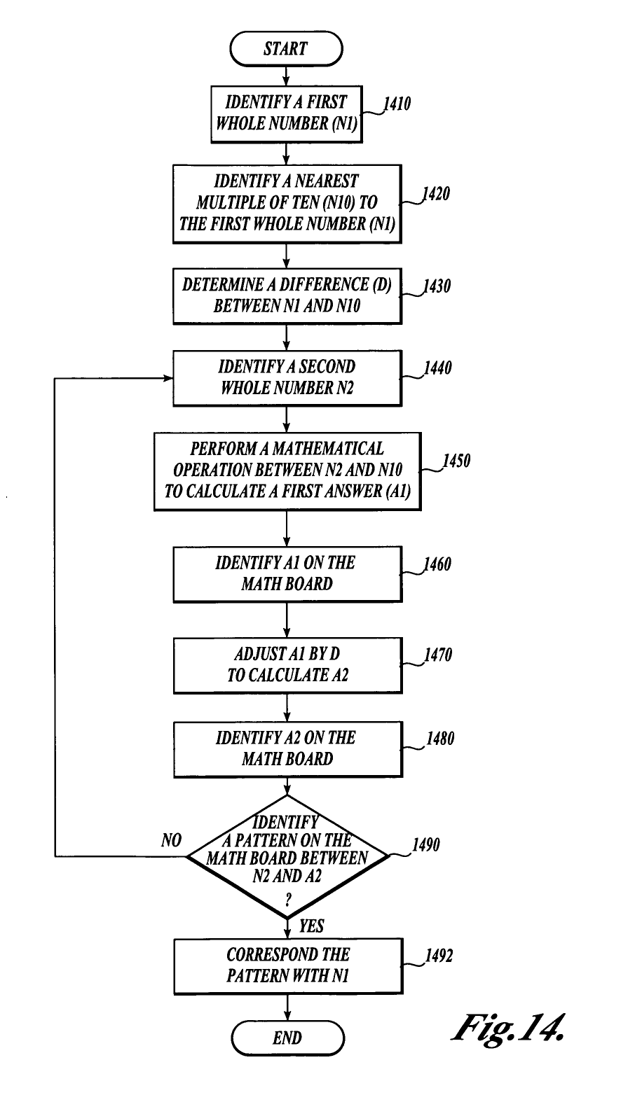

Referring to FIG. 13A, multiplying by “11” on the math board 22 is similar to multiplying by “9”, but it includes a horizontal step in the opposite direction as well as a vertical step because “11” is one more than “10”. For example, when multiplying 11×1, the answer is A=11. When multiplying 11×2, the answer is A=22, which is one column to the right and one row down from “11” on the math board 22. When multiplying 11×3, the answer is A=33, which is one column to the right and one row down from “22” on the math board 22, and so on. Additional equations for multiplying by “11” are depicted in Table 7 that follows.

TABLE 7

| | |
|---|---|
| 11 × 0 = | 0 |
| 11 × 1 = | 11 |
| 11 × 2 = | 22 |
| 11 × 3 = | 33 |
| 11 × 4 = | 44 |
| 11 × 5 = | 55 |
| 11 × 6 = | 66 |
| 11 × 7 = | 77 |
| 11 × 8 = | 88 |
| 11 × 9 = | 99 |

The pattern on the math board 22 for multiplying by “11” is illustrated in FIG. 13A, and is thus associated with the number “11”. As mentioned above, the math game 20 further includes a math worksheet 1332 (FIG. 13B) having a math table 1336 specifically configured for the number “11”.

Referring to FIG. 13B, there is shown an example math worksheet 1332 having a math table 1336 specifically configured for the number “11”. The math table 1336 corresponds with the pattern generated on the math board 22 in FIG. 13A for multiplying by the number “11”, and includes ten columns 1338 and two rows 1340 of table cells 1342, filled with multiplying by “11” equations. The number of columns 1338 will remain the same in the math table 1336, because (as discussed in detail below) the products generated when multiplying by “11” will always end in the same ten numbers in the following pattern: “1”, “2”, “3”, “4”, “5”, “6”, “7”, “8”, “9”, and “0”. However, the number of rows 1340 for multiplying by “11” can theoretically continue on to infinity, because the number of products that can be generated when multiplying by “11” is infinite.

Still referring to the math worksheet of FIG. 13B, the multiplying by “11” equations 1344 are arranged in consecutive increasing order from left to right across each row 1340 beginning at the first row 1340 of the math table 1336. For example, the first equation is 11×1, the second equation is 11×2, and so on. The column headings 1346 include “1”, “2”, “3”, “4”, “5”, “6”, “7”, “8”, “9”, and “0”.

Some of the products 1348 for each of the multiplying by “11” equations have been filled in after the equations 1344 to show how the user would complete the math worksheet 1332. By referring to these products 1348, the reader will notice that each of the ten column headings 1346 corresponds with the numerals in the ones place of the products 1348 in the table cells 1342 below the headings 1346.

As discussed in detail above, the pattern for determining multiples of “11” in FIG. 13A is one horizontal step to the right for each vertical step down on the math board 22, as shown by arrows 50. Isolating the horizontal step, the ones place goes forward one whole number with each multiple continually on a number line from “0” to “9” (e.g., 11, 22, 33, 44, 55, 66, 77, 88, 99, 110, 121, and so on). Thus, the user can use the horizontal pattern generated on the math board 22 in FIG. 13A for multiplying by the number “11” to fill in the column headings 1346 of the math table 1336 (from left to right) as well as the products 1348 for “11s” multiplication on the math worksheet 1332 of FIG. 13B.

Using this horizontal step pattern of the math worksheet 1332 to establish the ones place for infinite rows 1340 (and thus infinite products 1348), the user can calculate products 1348 beyond those identified on the math board 22 of FIG. 13A (i.e., products greater than 99), for example 10×11=110, 11×11=121, etc. (see FIG. 13B). In addition, as detailed above with respect to multiplication by “9s”, the math worksheet 1332 for multiplication by “11s” also may be configured for more advanced multiplication learning.

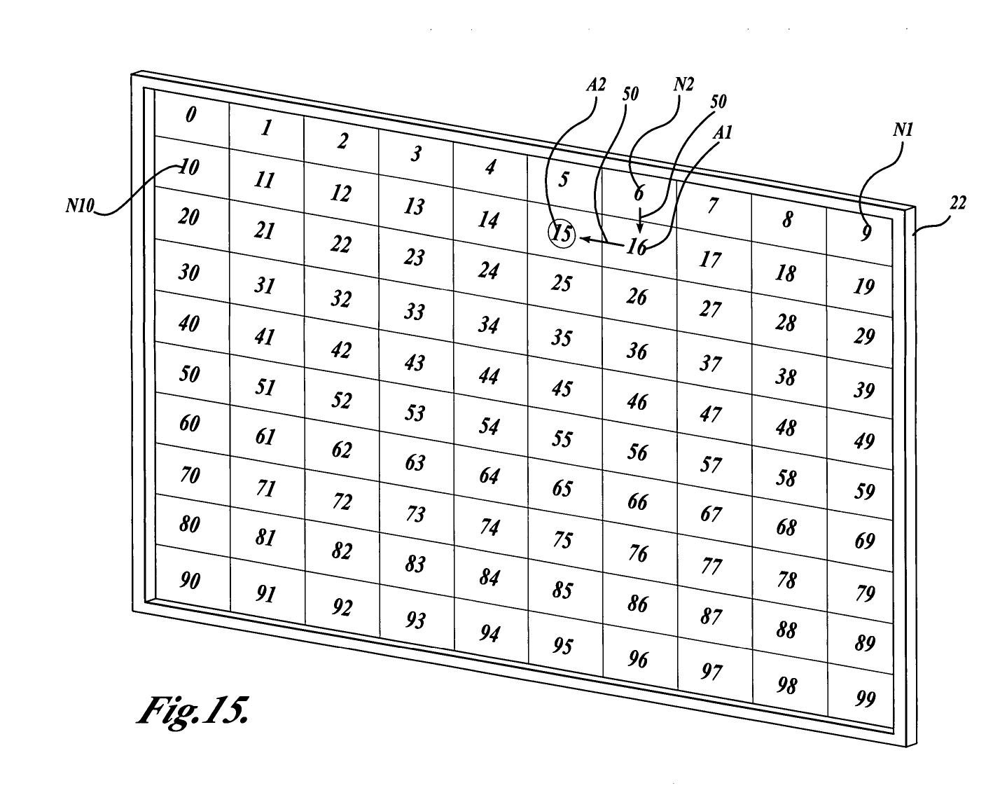

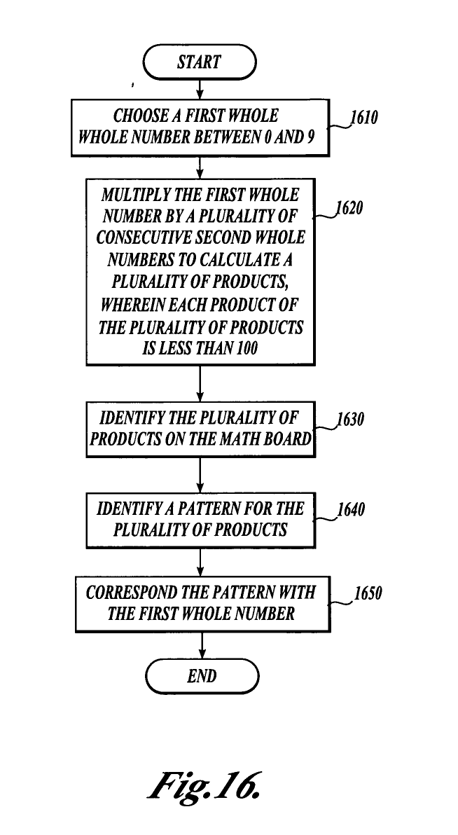

Referring to FIGS. 14 and 15, a general method of using the math game 20, which applies to addition, subtraction, multiplication, and division operations, will now be described. This method of using the math game 20 identifies a pattern or series of patterns for performing mathematical operations between a certain whole number (for example, the number “9”) and other whole numbers (for example, 9+6, 9+13, 9+27, etc.).

According to the general method of using a math game 20, and with reference to FIGS. 14 and 15, the user starts by identifying a first whole number N1 (such as N1=9) on the math board 22, as shown by block 1410. Then, the user identifies a nearest multiple of ten N10, which is the closest multiple of ten to the first whole number N1 on the math board 22, as shown by block 1420. As discussed above with reference to the “rule of 10,” the nearest multiple of ten accounts for the vertical step(s) on the math board 22 in the mathematical operation.

The user then determines a difference D between the first whole number N1 and the nearest multiple of ten N10. For example, if the user identifies the first whole number N1=9, then the nearest multiple of ten is N2=10, and the difference between N1 and N2 is D=N1−N2=9−10=(−1), as shown by block 1430. The difference D accounts for the horizontal step(s) on the math board 22 in the mathematical operation. In an addition operation, D=(−1) would account for one horizontal step to the left, and N10=10 would account for one vertical step down. (In a subtraction operation, D and N10 would account for opposite steps, i.e., D=(−1) would account for one horizontal step to the right, and N10=10 would account for one vertical step up.) The user then identifies a second whole number N2 on the math board 22, as shown by block 1440, and performs a math operation between the second whole number N2 and the nearest multiple of ten N10 to calculate a first answer A1, as shown by block 1450, and identifies the first answer A1 on the math board 22, as shown by block 1460. If the math operation is addition, then the equation for the math operation is N2+N10=A1. (For subtraction, the equation is N2−N10=A1.) If, for example N2=6, then the addition operation will be A1=N2+N10=6+10=16. The first answer A1, however, only considers the vertical step. Thus, the first answer A1 will still need to be adjusted for any necessary horizontal steps, as discussed in the paragraph that follows.

The user then adjusts the first answer A1 by the difference D to calculate the second answer A2, as shown by block 1470, and identifies the second answer A2 on the math board 22, as shown by block 1480. For example, A2=A1+D=16+(−1)=15.

If the user can identify a pattern on the math board 22 between the second whole number N2 and the second answer A2, then the user corresponds the pattern with the first whole number N1, as shown by block 1492. As discussed above, this method of using the math game 20 identifies a pattern or series of patterns for performing mathematical operations between a certain whole number, for example, the number “9”, and other whole numbers. In the example above, in which the first whole number is N1=9, the pattern established between the second whole number N2 and the second answer A2 is one horizontal step to the left and one vertical step down on the math board 22. Thus, for the addition of “9” to any other whole number on the math board 22, the pattern is exactly one horizontal step to the left and one vertical step down from the second whole number N2, as illustrated by arrows 50 in FIG. 15.

However, if the user cannot yet identify a pattern between the second whole number N2 and the second answer A2, then the user should maintain the first whole number N1, but return and choose another second whole number N2, continuing this process until the user can identify a pattern between the second whole number N2 and the second answer A2, as shown by block 1440. By plotting multiple numbers on the math board 22, the user will learn that he or she can add the whole number “9” (or any other whole number) to another whole number by following the established pattern relating to the whole number “9” (or the specific pattern related to any other whole number, as described in the examples above).

This method of using the math game 20, does not only apply to patterns in addition and subtraction. In fact, it can also be applied to patterns in multiplication and division by using additional calculations to adjust the first answer A1 and difference D. If the mathematical operation is multiplication, the first answer A1 is adjusted by subtracting the difference D multiplied by the second whole number N2 to calculate the second answer A2. If the mathematical operation is division, the first answer A1 is adjusted by subtracting the difference D divided by the second whole number N2 to calculate the second answer A2.

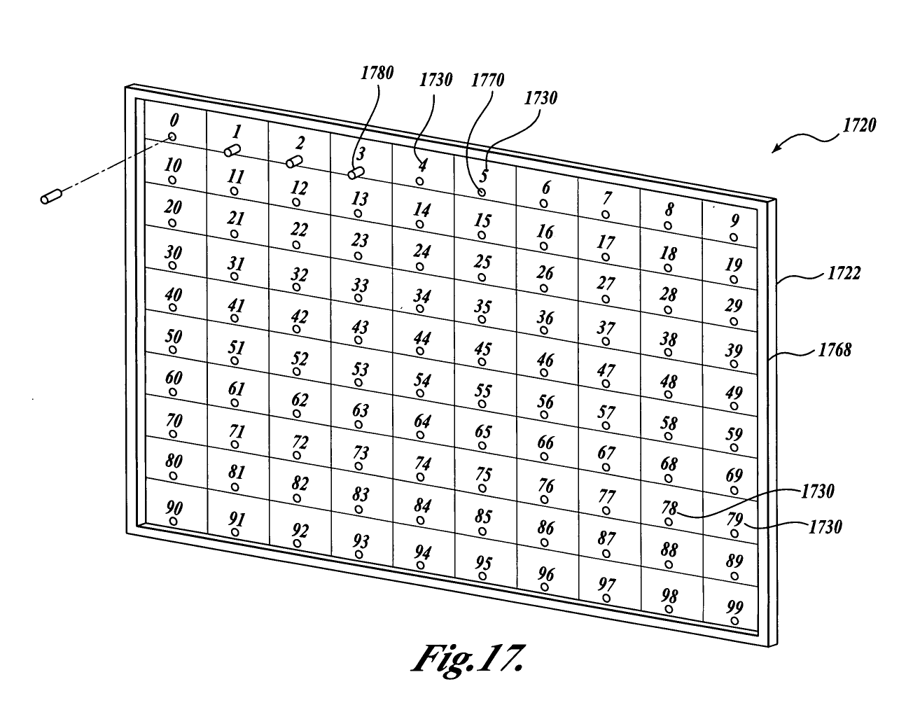

Referring to FIG. 16, another method of using a math game 20, which applies to multiplication and division, is described. This method of using the math game 20 generates a pattern for performing multiplication and division operations between a certain whole number (for example, the number “9”) and other whole numbers (for example “0” to “9”).

First, the user chooses a first whole number between “0” and “9” (including “0” and “9”), as shown by block 1610. Then, the user multiplies the first whole number by a plurality of consecutive second whole numbers to calculate a plurality of products, wherein each product of the plurality of products is less than 100, as shown by block 1620. The user then identifies the plurality of products on the math board 22, as shown by block 1630, and identifies a pattern for generating the plurality of products on the math board 22, as shown by block 1640. The user then corresponds the pattern of the products on the math board 22 with the first whole number, as shown by block 1650. By correlating this pattern with the first whole number, the user can remember the pattern to arrive at products and quotients more easily, and the user can anticipate products and quotients off the math board based on the pattern.

The math game 20 further includes methods of instructing mathematics wherein the user will be prompted to perform activities and/or provide input on the math board 22 based on the patterns developed above, for example, including written instruction, oral instructions, and/or instructions implemented in software. It should be appreciated that these instructions may vary according to exemplary whole numbers or multiplication tables.

A representative instruction will prompt the user to count forward and backward by “9s” on the math board 22 to generate and/or regenerate the pattern for multiplication by “9s”, as identified in FIG. 9A.

Another representative instruction will prompt the user to count on the number line, which is the first row on the math board 22 comprising whole numbers “0” to “9”. A representative instruction will prompt the user to utilize the number line of the math board 22 to perform division. As a first non-limiting example, a representative instruction will prompt the user to determine an answer to a division equation, for example, 63/9. A representative answer will be as follows: beginning at the number “9” on the number line (and counting the number “9”), the user counts back on the pattern for the number “9”, landing only on the numbers of the order of the pattern for the number “9” (9, 8, 7, 6, 5, 4, 3, 2, 1, 0, as identified in the column headings 946 of FIG. 9B) to the number “3” on the number line seven horizontal steps. Therefore, the user determines that 63/9=7.

As a second non-limiting example, a representative instruction will prompt the user to determine the answer to another division equation, for example, 56/7. A representative answer will be as follows: beginning at the number “7” on the number line (and counting the number “7”), the user counts back on the pattern for the number “7”, landing only on the numbers of the order of the pattern for the number “7” (7, 4, 1, 8, 5, 2, 9, 6, 3, 0 as identified in the column headings 1146 of FIG. 11B) to the number “6” on the number line eight horizontal steps. Therefore, the user determines that 56/7=8.

Another representative instruction will prompt the user to identify what product comes before and after another product within a certain multiplication table on the math board 22. As a non-limiting example, a representative instruction will prompt the user to identify the products that come before and after “90” in multiplication by “9s” on the math board 22. A representative answer is that “81” comes before “90”, and “99” comes after “90” within the pattern for multiplication by “9s”, as identified in FIG. 9A.

Another representative instruction will prompt the user to compare two different multiplication tables with different indicia (such as different colored pens, or other indicia) on the math board 22. As a first on-limiting example, a representative instruction will prompt the user to compare a “5s” multiplication table (not shown) and the “9s” multiplication table (see FIG. 9A) on the math board 22, and identify the “anchor” indicia (i.e., products in which the multiplication tables intersect). A representative answer will be “0”, “45”, and “90”.

As a second non-limiting example, a representative instruction will prompt the user to compare the “6s” multiplication table (see FIG. 12A) and the “9s” multiplication table (see FIG. 9A) on the math board 22, and identify the “anchor” indicia. A representative answer will be “0”, “18”, “36”, “54”, “72”, and “90”.

As a third non-limiting example, a representative instruction will prompt the user to compare a “4s” multiplication table (not shown), the “6s” multiplication table (see FIG. 12A), and the “9s” multiplication table (see FIG. 9A) on the math board 22, and identify the “anchor” indicia. A representative answer will be “0”, “36”, and “72”.

Another representative instruction will prompt the user to remove all indicia from the comparison multiplication tables of the previous example except for “anchor” indicia. As a non-limiting example, and in accordance with the above representative instruction, the instruction will prompt the user to maintain “anchors” as products “9”, “45”, and “90”. It should be appreciated that the instruction may then prompt the user to identify the products that come before and after different multiples “9” with the “anchors” in place, as discussed above in another representative instruction. As a first non-limiting example, a representative instruction will prompt the user to identify the products that come before and after “45” in multiplication by “9s” on the math board 22. A representative answer is that “36” comes before “45”, and “54” comes after “45” within the pattern for multiplication by “9s”, as identified in FIG. 9A.

As a second non-limiting example, a representative instruction will prompt the user to identify the products that come two multiples before and two multiples after “45” in multiplication by “9s” on the math board 22. A representative answer is that “27” comes two multiples before “45”, and “63” comes two multiples after “45” within the pattern for multiplication by “9s”, as identified in FIG. 9A.

Another representative instruction will prompt the user to identify multiplication table equation products on the math board 22. As a non-limiting example, the representative instruction will prompt the user to identify 9×1, 9×2, and the other equations identified in Table 2 above. It should be appreciated that this representative instruction may include identifying “anchor” indicia, such as “9”, “45”, and “90” identified in the non-limiting example above.

Another representative instruction will prompt the user to identify the quotients of multiplication table products on the math board 22. As a non-limiting example, instead of prompting the user to identify the product of 9×4, the representative instruction will prompt the user to identify the quotient of 36/9. A representative answer will be “4”.

Although most of the above representative instructions were all considered in light of multiplication by “9s” and FIG. 9A, it should be appreciated that all of the above representative instructions may be applied to any of the multiplication tables, including those identified in the non-limiting examples of FIGS. 9A, 10A, 11A, 12A, and 13A, or any other multiplication tables not identified in those examples. In addition the representative instructions may include any number of examples with different whole numbers, whether products, quotients, multiples, or divisors. Moreover, representative instructions may also prompt the user to add two or more whole numbers or subtract one or more whole numbers from another, or perform any combination of operations in any order, including addition, subtraction, multiplication, and/or division.

Now referring to FIG. 17, a math game in accordance with another embodiment of the present disclosure will be described in greater detail. The math game of this embodiment is substantially identical in materials and operation as the previously described embodiment, except for the differences regarding the use of the math board, including the identification of numbers on the math board, which will be described in detail below. For clarity in the ensuing descriptions, the numeral references for elements that are similar to those of the math game 20 of FIG. 1 are in the 1700 series for the illustrated embodiment of FIG. 17.

In the embodiment illustrated in FIG. 17, the math game 1720 includes a rectangular-shaped board 1722, including a frame 1768, with a plurality of holes 1770 for releasably receiving a plurality of pegs 1780. The pegs 1780 are insertable to and removable from the board 1722 by the user for selecting or identifying whole numbers 1730 without the use of a writing utensil.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. While the preferred embodiment of the disclosure has been illustrated and described, it will be appreciated that various changes can be made therein without departing from the spirit and scope of the disclosure.

The embodiments of the disclosure in which an exclusive property or privilege is claimed are defined as follows:

1. An apparatus, comprising:
a math board having a plurality of rows and a plurality of columns, wherein the plurality of rows and the plurality of columns form a plurality of grid cells, and a plurality of whole numbers arranged in consecutive order, wherein the plurality of whole numbers are disposed within the plurality of grid cells, and wherein the plurality of grid cells are capable of being used to identify a pattern in a numerical operation.

2. The apparatus of claim 1, wherein the plurality of whole numbers range from 0 to 99.

3. The apparatus of claim 1, wherein the numerical operation comprises at least one of addition, subtraction, multiplication, and division.

4. The apparatus of claim 1, wherein at least one row of the math board is utilized as a number line to identify a pattern in a numerical operation.

5. The apparatus of claim 1, embodied in computer readable instructions stored on a computer accessible medium.

6. The apparatus of claim 1, further comprising a math worksheet, wherein the math worksheet is used to teach mathematics by applying a pattern in a numerical operation identified on the math board.

7. The apparatus of claim 6, wherein the math worksheet comprises at least one table for recording answers achieved by applying a pattern in a numerical operation identified on the math board.

8. The apparatus of claim 1, wherein the numerical operation is multiplication, and the pattern identifies products of a given whole number.

9. The apparatus of claim 1, wherein the numerical operation is division, and the pattern identifies quotients of a given whole number.

10. The apparatus of claim 1, wherein the numerical operation is addition, and the pattern identifies sums of a given whole number.

11. The apparatus of claim 1, wherein the numerical operation is subtraction, and the pattern identifies differences of a given whole number.

12. The apparatus of claim 1, wherein the pattern includes at least one of a vertical step and a horizontal step from a given whole number.

13. A method of teaching using a math board, comprising:
(a) identifying a first whole number;
(b) identifying a nearest multiple of ten to the first whole number;
(c) determining a difference between the first whole number and the nearest multiple of ten to the first whole number;
(d) identifying a second whole number;
(e) performing a mathematical operation between the second whole number and the nearest multiple of ten to the first whole number to calculate a first answer;
(f) identifying the first answer on the math board;
(g) adjusting the first answer by the difference to calculate a second answer;
(h) identifying the second answer on the math board;
(i) identifying a pattern on the math board between the second whole number and the second answer; and
(j) corresponding the pattern with the first whole number.

14. The method of claim 13, wherein the pattern includes at least one of a vertical step and a horizontal step from the first whole number.

15. The method of claim 13, wherein the mathematical operation is at least one of addition or subtraction, and wherein the first answer is adjusted by subtracting the difference to calculate the second answer.

16. The method of claim 13, wherein the mathematical operation is multiplication, and wherein the first answer is adjusted by subtracting the difference multiplied by the second whole number to calculate the second answer.

17. The method of claim 13, wherein the mathematical operation is division, and wherein the first answer is adjusted by subtracting the difference divided by the second whole number to calculate the second answer.

18. A method of using a math board, comprising:
(a) choosing a first whole number between 0 and 9;
(b) multiplying the first whole number by a first plurality of consecutive whole numbers to calculate a first plurality of products;
(c) identifying the first plurality of products on the math board;
(d) identifying a first pattern for the first plurality of products; and
(e) corresponding the first pattern with the first whole number.

19. The method of claim 18, wherein the first pattern identifies products of the first whole number.

20. The method of claim 18, wherein the first pattern includes at least one of a vertical step and a horizontal step from the first whole number.

21. The method of claim 18, further comprising:
(f) choosing a second whole number between 0 and 9;
(g) multiplying the second whole number by a second plurality of consecutive whole numbers to calculate a second plurality of products;
(h) identifying the second plurality of products on the math board;
(i) identifying a second pattern for the second plurality of products;
(j) corresponding the second pattern with the second whole number; and
(k) identifying an intersection between the first pattern and the second pattern.
